(19) United States
(12) Patent Application Publication
(10) Pub. No.: US 2015/0311987 A1
(43) Pub. Date: Oct. 29, 2015

(54) Smart Hybrid Combiner

(71) Applicant: EXTENET SYSTEMS, INC., Lisle, IL (US)

(72) Inventor: Christopher S. Meyer, Lisle, IL (US)

(73) Assignee: EXTENET SYSTEMS, INC., Lisle, IL (US)

(21) Appl. No.: 14/259,486

(22) Filed: Apr. 23, 2014

(51) Int. Cl. H04B 17/10; H04B 1/04; H04B 1/03; G08B 21/18

(52) U.S. Cl. CPC H04B 17/101; G08B 21/182; H04B 1/04; H04B 1/03

(57) ABSTRACT

Some embodiments of the present disclosure provide a smart combiner that includes a radio frequency (RF) power coupler having a first input, a second input, a first output, and a second output. The smart combiner further includes a first RF power detector coupled between the first input and the first output, and a second RF power detector coupled between the second input and the second output. The first RF power detector may be configured to monitor a power level of a signal at the first input, and the second RF power detector may be configured to monitor a power level of a signal at the second input. Further, the first RF power detector and the second RF power detector may be further configured to transmit a signal to an external computing device based on the monitored power levels.

### BACKGROUND

A wireless communication system typically provides one or more forms of wireless access to mobile access devices, enabling them to engage in voice and data communications with other devices—both wired and wireless—operating in or connected to the system, and to partake in various other communication services provided or supported by the system. The communication path from a mobile access device, such as a cellular telephone, personal digital assistant (PDA), or an appropriately equipped portable computer, for instance, to one or more other communication endpoints generally traverses a radio frequency (RF) air interface to a base transceiver station (BTS) or other form of access point, and on into a core transport network via a base station controller (BSC) connected to a mobile switching center (MSC) or to a packet data serving node (PDSN). The MSC supports primarily circuit voice communications, providing interconnectivity with other MSCs and PSTN switches, for example. The PDSN supports packet data communications, providing interconnectivity with packet-data networks, such as the Internet, via other packet-data switches and routers.

In a cellular wireless system, the BTS, BSC, MSC, and PDSN, among possibly other components, comprise the wireless access infrastructure, also sometimes referred to as the radio access network (RAN). A RAN is usually arranged according to a hierarchical architecture, with a distribution of multiple BTSs that provide areas of coverage (e.g., cells) within a geographic region, under the control of a smaller number of BSCs, which in turn are controlled by one or a few regional (e.g., metropolitan area) MSCs. As a mobile device moves about within the wireless system, it may hand off from one cell (or other form of coverage area) to another. Handoff is usually triggered by the RAN as it monitors the operating conditions of the mobile device by way of one or more signal power levels reported by the device to the RAN.

As the demand for wireless services has grown, and the variety of physical environments in which wireless access is provided becomes more diverse, the need for new topologies and technologies for coverage has become increasingly important. At the same time, alternative methods of wireless access, including WiFi and WiMax, are becoming more ubiquitous, particularly in metropolitan areas. Consequently, traditional cellular service providers are looking for ways to integrate different types of wireless access infrastructures within their core transport and services networks. In addition, as wireless access infrastructures of different service providers tend to overlap more and more within smaller spaces, the ability to share common infrastructure offers cost and operational benefits to network owners and operators.

### OVERVIEW

Some embodiments of the present disclosure provide a smart combiner that includes a radio frequency (RF) power coupler having a first input, a second input, a first output, and a second output. The smart combiner further includes a first RF power detector coupled between the first input and the first output, and a second RF power detector coupled between the second input and the second output. The first RF power detector may be configured to monitor a power level of a signal at the first input, and the second RF power detector may be configured to monitor a power level of a signal at the second input. Further, the first RF power detector and the second RF power detector may be further configured to transmit a signal to an external computing device based on the monitored power levels.

Some embodiments of the present disclosure provide a method, that includes detecting a power level of a signal at a first input of a radio frequency (RF) power coupler, and detecting a power level of a signal at a second input of the RF power coupler. The method further includes receiving at a processing unit indications of the detected power levels from the first RF power detector and the second RF power detector, and based on the received indications of the detected power levels, determining that an alarm condition is satisfied. And the method includes, in response to determining that an alarm condition is satisfied, transmitting an alarm signal to an external device.

Some embodiments of the present disclosure provide a distributed antenna system (DAS). The DAS includes a plurality of antenna arrangements distributed throughout a network, and for each given antenna arrangement of the plurality of antenna arrangements, a radio frequency (RF) power coupler coupled to the given antenna arrangement. The RF power coupler may include at input and an output, with at least one of the input and the output being coupled to the given antenna arrangement, and an RF power detector coupled between the input and the output, the RF power detector being configured to monitor a power level of a signal at input. Further, in some embodiments, the RF power detector is configured to transmit a signal to a network operations center (NOC) based on the monitored power level.

These as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the disclosure by way of example only and, as such, that numerous variations are possible. For instance, structural elements and process steps can be rearranged, combined, distributed, eliminated, or otherwise changed, while remaining within the scope of the disclosure as claimed.

### BRIEF DESCRIPTION OF THE DRAWINGS

FIG. 1 depicts an example of a wireless communication system in which embodiments of a smart combiner could be deployed.

FIG. 2 depicts an example deployment of DAS architecture, in accordance with one embodiment.

FIG. 3 depicts an example arrangement that includes a smart combiner, in accordance with one embodiment.

FIG. 4 depicts an example smart combiner, in accordance with one embodiment.

FIG. 5 depicts an example deployment of DAS architecture with smart combiners, in accordance with one embodiment.

FIG. 6 is a flowchart depicting an example method of operation of a smart combiner, in accordance with one embodiment.

### DETAILED DESCRIPTION

### 1. Overview of Example Network Architecture

The present disclosure will be described by way of example with reference to wireless access technologies including Code Division Multiple Access (CDMA), UMTS, GSM, WiFi, and WiMax, although the disclosure is not limited to these technologies. CDMA and GSM are typically deployed in cellular wireless communication systems, and generally encompass a number of related technologies that collectively and/or individually support both circuit-cellular communications, including voice and circuit-based packet communications, and native packet-data communications. For the purposes of the discussion herein, a “CDMA family of protocols” shall be taken to apply to all such technologies. Examples of protocols in the family include, without limitation and of one or more versions, IS-95, IS-2000, IS-856, and GSM, among others. Native packet-data wireless protocols and technologies, include, without limitation WiFi, WiMax, WLAN, and IEEE 802.11, some or all of which may be interrelated. The term “wireless Ethernet” is also sometimes used to describe one or another of these protocols or aspects of these protocols.

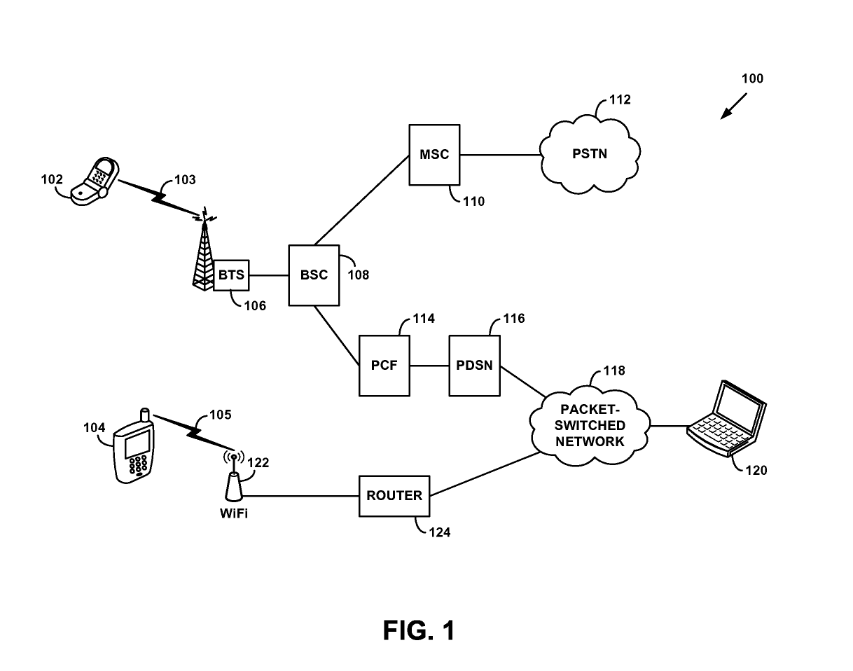

FIG. 1 depicts an example wireless communication system owned and/or operated by a service provider in which example embodiments of a smart combiner could be deployed. A wireless access device 102 is communicatively connected to the system by way of an RF air interface 103 to a BTS 106, which in turn is connected to a BSC 108. The RF air interface 103 is defined and implemented according to one or more of a CDMA family of protocols. The BSC 108 is connected to an MSC 110 for circuit-cellular communications, and via a packet control function (PCF) 114 to a PDSN 116 for packet data communications. The MSC is connected to a PSTN 112, thus providing a communication path to landline circuit networks. The connection to the PSTN 112 is also intended to represent trunk connections between the MSC 110 and other circuit switched, including (without limitation) local exchange switches, interexchange switches for long-distance services and interconnections with other carriers' networks, and other MSCs both in the carrier's network and other carriers' networks.

As indicated, the PDSN 116 is connected to a packet-switched network 118, which could be the Internet or a core packet transport network that is part of the wireless communication system. A computer 120 is also shown being connected to the packet network 118, and the wireless device 102 could engage in communications with the computer 120 via a path such as the one just described. It will be appreciated that, although not shown, other communication devices, as well as communication and application servers could be connected in one way or another to the network 118. In addition, the network 118 may comprise other equipment including, without limitation, routers, switches, transcoding gateways, security gateways and firewalls, and other components typical of a communication and transport network.

Also shown in FIG. 1 is a second wireless access device 104, which is connected to the wireless communication system via the air interface 105 to a WiFi access point 122. The access point is in turn connected to a router 124, which then connects to network 118. Although not shown for the sake of brevity, it will be appreciated that this connection could include other packet routing/processing elements. The access device 104 could also engage in communications with one or more communication endpoints via the physical path shown in the figure. The detailed protocols and methods for establishing communications between either of the devices 102 or 104 and other devices and communication endpoints in the network are well-known, and not discussed further herein.

It should be understood that the depiction of just one of each network element in FIG. 1 is illustrative, and there could be more than one of any of them, as well as other types of elements not shown. The particular arrangement shown in FIG. 1 should not be viewed as limiting with respect to the present disclosure or embodiments thereof. Further, the network components that make up a wireless communication system such as the system 100 are typically implemented as a combination of one or more integrated and/or distributed platforms, each comprising one or more computer processors, one or more forms of computer-readable storage (e.g., disks drives, random access memory, etc.), one or more communication interfaces for interconnection between elements and the network, and operable to transmit and receive the communications and messages described herein, and one or more computer software programs and related data (e.g., machine-language instructions and program and user data) stored in the one or more forms of computer-readable storage and executable by the one or more computer processors to carry out the functions, steps, and procedures of the various embodiments of the present disclosure described herein. Similarly, a communication device, such as the example access devices 102 and 104, typically comprises a user-interface, I/O components, a communication interface, a tone detector, a processing unit, and data storage, all of which may be coupled together by a system bus or other mechanism.

### 2. Example Distributed Antenna System Architecture

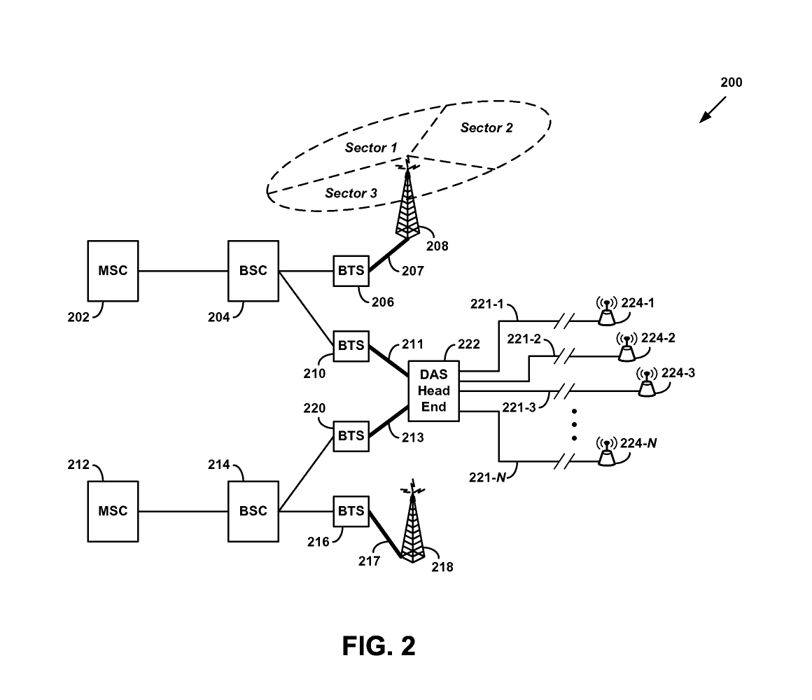

FIG. 2 depicts a high-level view of an implementation of a distributed antenna system (DAS) network 200 according to an example configuration of a standard architecture. By way of example, the DAS implementation in FIG. 2 is shown as providing a common access infrastructure for multiple BTSs. As shown, network 200 includes a first MSC 202, which is connected to a first BSC 204, which in turn is connected to BTS 206 and BTS 210. The BTS 206 is a traditional BTS, having a high-power digital radio connection 207 to an antenna tower 208. In practice, a digital connection 207 carries a signal with a power of roughly 20 watts (W), and is commonly implemented as a coaxial cable between the BTS and an RF transmission component that transmit the RF signal via antenna elements at or near the top of the tower. The broadcast signal generally has a power level similar to that of the input (i.e., roughly 20 W).

The coverage area provided by the BTS (including the transmitting antennas) is typically a cell or cell sectors. By way of example, the BTS 206 (in conjunction with the antenna tower 208) is sectorized, such that it provides three sectors (labeled “Sector 1,” “Sector 2,” and “Sector 3”). An access device then communicates on a connection via one or more of the cells or sectors of a BTS in accordance with one or more of a family of CDMA protocols. For instance, under IS-2000, each cell or sector will be identified according to a locally unique identifier based on a bit offset within a 16-bit pseudo-random number (PN). An access device operating according to IS-2000 receives essentially the same signal from up to six sectors concurrently, each sector being identified and encoding transmissions according its so-called PN offset. The details of such communications are well-known in the art and not discussed further here.

Signals received from access devices connected via the antenna tower 208 are transmitted back to the BTS 206 via the connection 207. Unlike the BTS 206, which supplies the antenna tower 208, the BTS 210 is connected instead to a DAS head end 222 via a digital RF connection 211. The digital connection 211 is the same type of signal and physical interface as the connection 207. However, rather than supplying a single transmission tower, the DAS head end 222 splits and distributes the input signal from the BTS among several smaller and remote antenna nodes 224-1, 224-2, 224-3, . . . , 224-N, where N is a positive integer. Connections from the DAS head end 222 to each of the remote nodes 224-1, 224-2, 224-3, . . . , 224-N may be made via low-power digital-optical links 221-1, 221-2, 221-3, . . . , 221-N, respectively. Hatch marks interrupting each of the links 221 are meant to represent the remoteness of each node's location with respect to the DAS head end. The remote nodes could be distributed throughout one or more buildings, or across a residential area or small down-town locale or village where a larger antenna tower is impractical and/or impermissible according local zoning ordinances, for instance.

The combination of signals then transmitted from the remote nodes 224-1, 224-2, 224-3, . . . , 224-N provides the same signals that would be transmitted from one or more cells or sectors if they were connected to the BTS 210, but spread over a region according to the topological arrangement of the nodes and the splitting and routing of the input signals by the DAS head end (this is discussed further below). Signals received from access devices connected via one or more of the remote antenna nodes are received at the DAS head end, combined, then transmitted back to the BTS 210 via the connection 211, in the same way as in the traditional BTS (e.g., transmissions from the RF module 208 to the BTS 206).

FIG. 2 also depicts a second set of network equipment, namely MSC 212, BSC 214, BTS 216 and 220, and radio transmission tower 218, which may be a part of another service provider different than that of MSC 202, BSC 204, BTS 206 and 210, and radio transmission tower 208. More particularly, MSC 212 is connected to BSC 214, which in turn is connected to a BTS 216 and a BTS 220. Similar to the BTS 206, a traditional BTS 216 is connected to a radio transmission tower 218 via a high-power digital-RF connection 217. Note that for both traditional BTSs, the BTS units (206 and 216) are typically collocated with their respective RF transmission towers. As shown, the BTS 220 connects to a DAS head end 222 via a high-power digital radio connection 213, which again is the same type of connection as the connections 207, 211, and 217. Because the interface between the BTS and DAS head is the same for both BTS 210 and BTS 220, both service providers of the BTSs can connect to the common DAS head end and thereby share the same remote antenna node access infrastructure.

While the connections 211 and 213 are of the same type, each carries a signal (or signals) that is (or are) specific to the particular service provider. For example, both service providers could be operating according to IS-2000, but each using a different RF carrier frequency. Alternatively or additionally, one carrier could be operating according to CDMA and the other according to GSM. Other combinations of technologies and RF carriers could be used. In addition, each carrier could have a different configuration of cell or sector identifiers. For instance, the BTS 210 could be configured for three sectors, while the BTS 220 could be configured for a single cell. Any similarities or differences between the two systems are incorporated into their respective signals prior to being modulated onto their respective carriers by their respective BTSs (210 and 220 in this example). The DAS head end just splits and routes the respective signals to the remote antenna nodes, which then transmit the various carrier signals concurrently. Thus, the output of the antenna nodes potentially comprises a mix of CDMA technologies, RF carrier frequencies, and coverage area (e.g., cell or sector) configuration.

### 3. Example Network Architecture with Smart Combiner

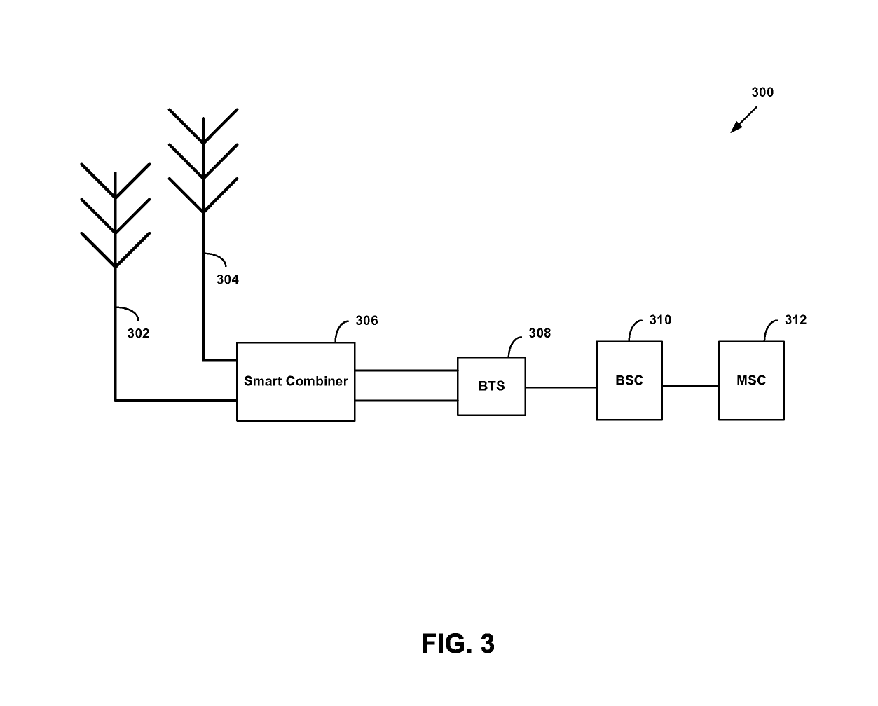

FIG. 3 depicts select components of an example network 300 that incorporates a smart combiner 306. As depicted, network 300 includes a first antenna arrangement 302 and a second antenna arrangement 304, both of which may make up at least part of a radio transmission tower situated at a cell site. The first antenna arrangement 302 and the second antenna arrangement 304 feed into the smart combiner 306 via respective coaxial cables. Smart combiner 306 provides the signals received from antenna arrangements 302 and 304 to a BTS 308, which in turn is coupled to a BSC 310 and an MSC 312, similar to corresponding portions of network 200 depicted in FIG. 2.

As a general matter, a smart combiner may be utilized to provide cell sites, and ultimately the network at large with on-site, health monitoring of certain network components. For example, in the embodiment depicted in FIG. 3, smart combiner 306 is utilized to provide network 300 with on-site, health monitoring of antenna arrangements 302 and 304. But more particularly, in some embodiments, the smart combiner may monitor and detect localized network problems that affect network integrity and/or network performance. One the one hand with regard to network-integrity problems, the smart combiner may determine whether certain network components are outputting and/or transmitting power as planned. For example, if a certain network component becomes damaged, that network component may not properly output or transmit power as designed. The smart combiner may be operable to monitor and detect a power deficiency associated with the damaged component.

On the other hand with regard to network performance, the smart combiner may determine whether communication signals are being adequately transmitted throughout the network. For example, if a mobile device is receiving a communication signal with insufficient signal strength, a smart combiner (or arrangement of smart combiners positioned throughout the network) may be able to localize the portion of the network giving rise to the insufficiency. Other uses for a smart combiner are possible as well.

Once a smart combiner detects a problem condition, the smart combiner may notify a network operations center (NOC) (not shown), which may dispatch a technician or otherwise provide for mitigation of the problem condition. Positioning smart combiners throughout a network, and particularly throughout a DAS network given the tendency of DAS networks to include components distributed throughout a relatively large geographic area, may enable the NOC (or other monitoring entity) to more efficiently monitor and maintain the overall health of the network.

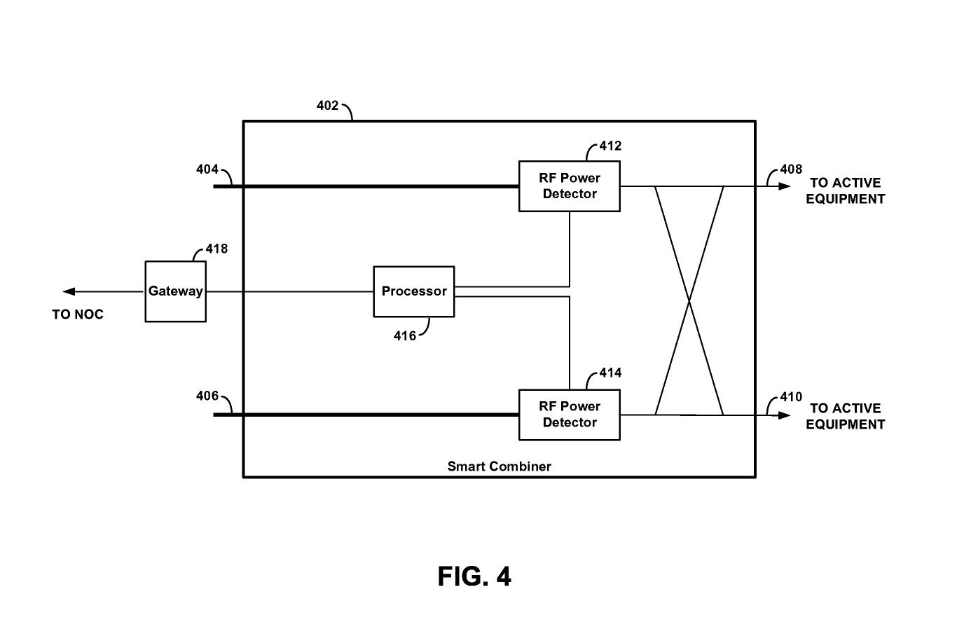

In some embodiments, the smart combiner may be a traditionally passive component that includes some active components. For instance, FIG. 4 depicts an example smart combiner 402 that is a traditionally passive 2×2 power combiner; however, in other embodiments the smart combiner may be a 3×3 power combiner, a 4×4 power combiner, some other form of RF power multiplexer, or some other passive component altogether. As depicted in FIG. 4, smart combiner 402 includes a first input 404 and a second input 406. In one example implementation, input 404 and input 406 are coupled to respective antenna arrangements via coaxial cable, although other implementations are possible. Smart combiner 402 is also depicted as including a first output 408 and a second output 410. In one embodiment the power received via inputs 404 and 406 is multiplexed to provide similar power levels at the outputs. Outputs 408 and 410 may be coupled to downstream active network equipment, such as a BTS, BSC, MSC, or some other downstream network component.

As also depicted, smart combiner 402 includes active components, such as a first RF power detector 412 positioned between input 404 and output 408, and a second RF power detector 414 positioned between and a second RF power detector 414, positioned between input 406 and output 410. RF power detector 412 operates to monitor various characteristics of signals at the input 404 and relay the monitored characteristics to a processor 416. RF power detector 414 likewise operates to monitor various characteristics of signals at the input 406 and relay the monitored characteristics to a processor 416. Processor 416 may be a special-purpose microprocessor or, alternatively, part of a more sophisticated computing device, such as a traditional desktop or notebook computer. As will be explained further below, the processor 416 may be programmed with, or otherwise configured to execute appropriate programming code in order to carry out one or more of the functions described herein with respect to the smart combiner. As further depicted the processor 416 is shown coupled to an external Gateway 418, which is configured to transmit signals to a NOC (not shown). In some configurations, RF power detectors 412 and 414, and processor 416 are enclosed within the same metallic housing, thereby encapsulating the components as a single, stand-alone device. However, in other configurations, the smart combiner may include more or fewer components, which may or may not be enclosed within a single housing.

In addition to the arrangement of the individual components of a smart combiner, the individual components of the smart combiner may be configured differently in different implementations of the smart combiner. For example, in accordance with one embodiment in which the smart combiner 402 is configured to monitor network integrity, the RF power detectors 412 and 414 may be configured to monitor the power provided at inputs 404 and 406 and transmit to the processor 416 an indication of the detected power levels. In one embodiment, the RF power detectors are configured to monitor the power level in a single frequency band; however, in other embodiments, the RF power detectors are configured to monitor the power level in multiple frequency bands, and perhaps monitor the power across the entire frequency spectrum.

Further, processor 416 may be configured to analyze the received indications of the power levels and determine whether any monitored power level falls below a particular threshold power level. And, in the event that the processor 416 detects that a monitored power level falls below a particular threshold power level, the processor 416 may generate and transmit to the NOC via Gateway 418 an appropriate alarm signal. Upon receiving the alarm signal, the NOC may dispatch a technician or otherwise provide for mitigation of the problem condition.

In accordance with another embodiment in which the smart combiner 402 is configured to monitor network integrity, the RF power detectors are configured to monitor undesirable harmonics (also known as RF noise) that may be present in signals at the inputs 404 and 406. Such harmonics may exist as a result of a damaged upstream network component, such as an antenna arrangement. RF power detectors 412 and 414 may be further configured to transmit to processor 416 an indication of any detected harmonics. Accordingly, processor 416 may be configured to analyze the received indications of the detected harmonics and determine whether there are at least a threshold level of unwanted harmonics present in a signal at one of the inputs 404 and 406. And, in the event that the processor 416 detects that there is at least a threshold level of unwanted harmonics present in a monitored signal, the processor 416 may generate and transmit to the NOC via Gateway 418 an appropriate alarm signal. Upon receiving the alarm signal, the NOC may dispatch a technician or otherwise provide for mitigation of the problem condition.

In accordance with another embodiment in which the smart combiner 402 is configured to monitor network performance, the RF power detectors are configured to monitor the signal-to-noise ratio (SNR) of signals at the inputs 404 and 406 and transmit to the processor 416 an indication of the detected SNR levels. Accordingly, processor 416 may be configured to analyze the received indications of the SNR levels and determine whether any monitored SNR level falls below a particular threshold SNR level. And, in the event that the processor 416 detects that a monitored SNR level falls below a particular threshold SNR level, the processor 416 may generate and transmit to the NOC via Gateway 418 an appropriate alarm signal. Upon receiving the alarm signal, the NOC may dispatch a technician or otherwise provide for mitigation of the problem condition. Other examples of smart combiner configurations are possible as well.

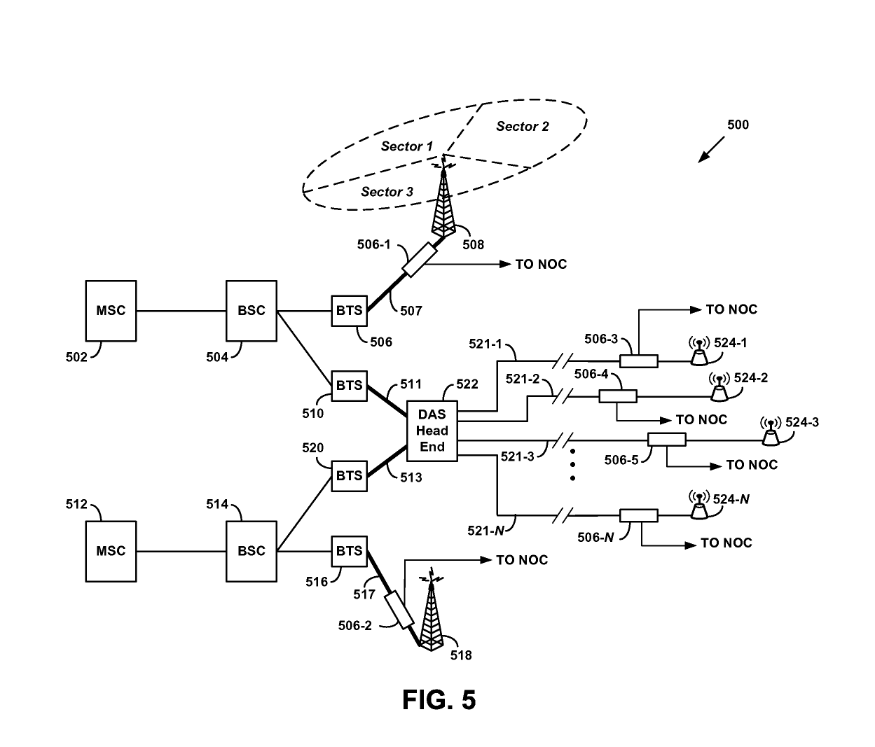

FIG. 5 depicts a high-level view of an implementation of a distributed antenna system (DAS) that incorporates multiple smart combiners. The DAS implementation depicted in FIG. 5 is similar to that of network 200 of FIG. 2. In particular, network 500 provides a common access infrastructure for multiple BTSs, including a first MSC 502, which is connected to a first BSC 504, which in turn is connected to BTS 506 and BTS 510. Similar to that of network 200, BTS 506 (in conjunction with the antenna tower 508) is sectorized, such that it provides three sectors (labeled “Sector 1,” “Sector 2,” and “Sector 3”).

Similarly, network 500 also includes a second set of network equipment, namely MSC 512, BSC 514, BTS 516 and 520, and radio transmission tower 518, which may be a part of another service provider different than that of MSC 502, BSC 504, BTS 506 and 510, and radio transmission tower 508. Signals received from access devices connected via the antenna tower 508 are transmitted back to the BTS 506 via the connection 507 through the smart combiner 506-1. As such, the smart combiner 506-1 may be utilized to provide on-site health monitoring of antenna tower 508, in accordance with any of the implementations set forth above. Likewise, signals received from radio transmission tower 518 are transmitted back to the BTS 516 via the connection 517 through the smart combiner 506-2. As such, the smart combiner 506-2 may be utilized to provide on-site health monitoring of the radio transmission tower 518, in accordance with any of the implementations set forth above.

As further shown in FIG. 5, the BTS 520 and BTS 510 connect to a DAS head end 522 via high-power digital radio connections 513 and 511. Further, the DAS head end 522 splits and distributes the input signal from the BTSs among several smaller and remote antenna nodes 524-1, 524-2, 524-3, . . . , 524-N, where N is a positive integer. Connections from the DAS head end 522 to each of the remote nodes 524-1, 524-2, 524-3, . . . , 524-N may be made via low-power digital-optical links 521-1, 521-2, 521-3, . . . , 521-N, respectively. Hatch marks interrupting each of the links 521 are again meant to represent the remoteness of each node's location with respect to the DAS head end. And as with network 200 in FIG. 2, the remote nodes of network 500 could be distributed throughout one or more buildings, or across a residential area or small down-town locale or village where a larger antenna tower is impractical and/or impermissible according local zoning ordinances, for instance.

As further depicted in network 500, the connections from the DAS head end 522 to each of the remote nodes 524-1, 524-2, 524-3, . . . , 524-N are transmitted through smart combiners 506-3, 506-4, 506-5, . . . , 506-N. As such, the smart combiners 506-3, 506-4, 506-5, . . . , 506-N may be utilized to provide on-site health monitoring of remote nodes 524-1, 524-2, 524-3, . . . , 524-N, in accordance with any of the implementations set forth above. Other DAS network configuration that incorporate smart combiners are possible as well.

### 4. Example Smart Combiner Method of Operation

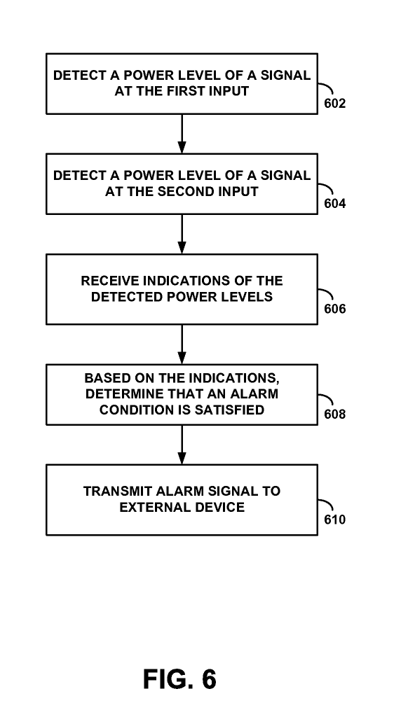

FIG. 6 is a flowchart depicting an example method that may be carried out by a smart combiner. The example methods depicted by the flowchart in FIG. 6 may include one or more operations, functions, or actions, as depicted by one or more of blocks 602, 604, 606, 608, and/or 610, each of which may be carried out by any of the components or systems described by way of FIGS. 1-5; however, other configurations could be used.

Furthermore, those skilled in the art will understand that the flowchart described herein illustrates functionality and operation of certain implementations of example embodiments. In this regard, each block of the flow diagram may represent a module, a segment, or a portion of program code, which includes one or more instructions executable by a processor (e.g., processor 416 described above with respect to FIG. 4) for implementing specific logical functions or steps in the process. The program code may be stored on any type of computer readable medium, for example, such as a storage device including a disk or hard drive, or electrically-erasable programmable read-only memory that may be integrated in or otherwise associated with processor 416 described above with respect to FIG. 4. In addition, each block may represent circuitry that is wired to perform the specific logical functions in the process. Alternative implementations are included within the scope of the example embodiments of the present application in which functions may be executed out of order from that shown or discussed, including substantially concurrent or in reverse order, depending on the functionality involved, as would be understood by those reasonably skilled in the art.

The method 600 begins at block 602, in which the smart combiner detects a power level of a signal at a first input of the smart combiner. As described above, the smart combiner may include an RF power detector positioned between an input and an output of the smart combiner. The RF power detector may be operable to monitor various characteristics of a signal at the input, including the power level.

Continuing at block 604, the smart combiner detects a power level of a signal at a second input of the smart combiner. As also described above, the smart combiner may include an RF power detector positioned between an additional input and an additional output of the smart combiner. The RF power detector may be operable to monitor various characteristics of a signal at the input, including the power level.

At block 606 the smart combiner receives at a processing unit indications of the power levels detected by the RF power detectors in blocks 602 and 604. As described above, the RF power detectors may transmit to the processing unit indications of the detected power levels upon detection.

Continuing at block 608, the smart combiner determines that an alarm condition is satisfied based on the received indications of the power levels. For instance, in one embodiment as described above, after receiving indications of the detected power levels, the processing unit may compare the detected levels to a threshold power level. And, in the event that the processor determines that one or more of the indicated power levels is less than or equal to the threshold power level, the processing unit may, as a result, determine that an alarm condition is satisfied.

For example, in some embodiments, the threshold power level is a constant number (e.g., 10 dBm). In this case, if the processing unit determines that an indicated power level is, for example, 8 dBm, then the processing unit may determine that the indicated power level is less than the threshold power level. In another example, the threshold power level is based on an average of some number of the previous indicated power levels (e.g., 90%). In this case, if the processing unit determines that an indicated power level has dropped by 10% or more from several of the previous indicated power levels, then the processing unit may determine that the indicated power level is less than the threshold power level. Other examples of determining whether an indicated power level is less than or equal to a threshold power level are possible as well.

In some embodiments, the processing unit may wait until an indicated power level has been less than the threshold power level for at least a threshold level of time (e.g., 2.0 seconds) before determining that the alarm condition is satisfied. This way, the smart combiner may let transient faults clear before taking an action with respect to the alarm condition.

Finally, at block 610, as a result of determining that an alarm condition is satisfied, the processing unit may transmit to an external device an alarm signal. For instance, as described above, the processing unit may transmit an alarm signal to an external device associated with an NOC, whereupon the NOC may, in response to receiving the alarm signal, dispatch a technician or otherwise provide for mitigation of the detected problem condition.

### 5. Conclusion

An example of an embodiment of the present disclosure has been described above. Those skilled in the art will understand, however, that changes and modifications may be made to the embodiment described without departing from the true scope and spirit of the disclosure, which is defined by the claims.

What is claimed is:

1. An apparatus comprising:
a radio frequency (RF) power coupler having a first input, a second input, a first output, and a second output;
a first RF power detector coupled between the first input and the first output, the first RF power detector being configured to monitor a power level of a signal at the first input; and
a second RF power detector coupled between the second input and the second output, the second RF power detector being configured to monitor a power level of a signal at the second input,
wherein the first RF power detector and the second RF power detector are further configured to transmit a signal to an external computing device based on the monitored power levels.

2. The apparatus of claim 1, further comprising a processing unit coupled to the first RF power detector and the second RF power detector, wherein the processing unit is configured to:
receive from the RF power detectors indications of the power levels of signals at the first input and the second input;
determine that, based on the received indications of power levels, an alarm condition is satisfied; and
transmit an alarm signal to the external computing device.

3. The apparatus of claim 2, wherein the processing unit is configured to determine that, based on the received indications of power levels, an alarm condition is satisfied by determining that at least one of the indicated power levels is less than a threshold power level.

4. The apparatus of claim 2, wherein the processing unit is configured to determine that, based on the received indications of power levels, an alarm condition is satisfied by determining that there are at least a threshold level of harmonics present in at least one of the signals at the first input or the second input.

5. The apparatus of claim 1, wherein the RF power coupler includes a housing, and wherein the first RF power detector and the second RF power detector are positioned within the housing.

6. The apparatus of claim 1, wherein the RF power coupler is a 2×2 power combiner.

7. The apparatus of claim 1, wherein the first input is coupled to a first antenna arrangement of a base station, and wherein the second input is coupled to a second antenna arrangement of the base station.

8. The apparatus of claim 1, wherein the first RF power detector and the second RF power detector are further configured to monitor power levels of signals across a plurality of frequency bands.

9. At a radio frequency (RF) power coupler that includes a first input coupled to a first RF power detector, a second input coupled to a second RF power detector, and a processing unit coupled to the first RF power detector and the second RF power detector, a method comprising:
the first RF power detector detecting a power level of a signal at the first input;
the RF second power detector detecting a power level of a signal at the second input;
the processing unit receiving indications of the detected power levels from the first RF power detector and the second RF power detector;
based on the received indications of the detected power levels, the processing unit determining that an alarm condition is satisfied; and
in response to the determining, the processing unit transmitting an alarm signal to an external device.

10. The method of claim 9, wherein the processing unit determining that an alarm condition is satisfied comprises the processing unit determining that at least one of the indications of the detected power levels is less than a threshold power level.

11. The method of claim 9, wherein the processing unit determining that an alarm condition is satisfied comprises the processing unit determining that there are at least a threshold level of harmonics present in at least one of the signals at the first input or the second input.

12. The method of claim 9, wherein the processing unit transmitting an alarm signal to an external device comprises the processing unit transmitting to a network operations center a signal indicative of the alarm condition.

13. A distributed antenna system (DAS) comprising:
a plurality of antenna arrangements distributed throughout a network; and
for each given antenna arrangement of the plurality of antenna arrangements, a radio frequency (RF) power coupler coupled to the given antenna arrangement, the RF power coupler comprising:
an input and an output, wherein at least one of the input and the output is coupled to the given antenna arrangement; and
an RF power detector coupled between the input and the output, the RF power detector being configured to monitor a power level of a signal at input, and
wherein the RF power detector is further configured to transmit a signal to a network operations center (NOC) based on the monitored power level.

14. The DAS of claim 13, wherein the RF power coupler further comprises a processing unit coupled to RF power detector, wherein the processing unit is configured to:
receive from the RF power detector and indication of the power levels of a signal at the input;
determine that, based on the received indication of the power level, an alarm condition is satisfied; and
transmit an alarm signal to the NOC.

15. The DAS of claim 14, wherein the processing unit is configured to determine that, based on the received indication of the power level, an alarm condition is satisfied by determining that the indicated power level is less than a threshold power level.

16. The DAS of claim 14, wherein the processing unit is configured to determine that, based on the received indication of the power level, an alarm condition is satisfied by determining that there are at least a threshold level of harmonics present in the signals at the input.

17. The DAS of claim 13, wherein the RF power coupler includes a housing, and wherein the RF power detector is positioned within the housing.

18. The DAS of claim 13, wherein the RF power coupler is a 2×2 power combiner.

19. The DAS of claim 13, wherein the input is coupled to a first antenna arrangement of a base station.

20. The DAS of claim 13, wherein the RF power detector is further configured to monitor power levels of signals across a plurality of frequency bands.
